(19) United States
(12) Patent Application Publication
(10) Pub. No.: US 2025/0317366 A1
(43) Pub. Date: Oct. 9, 2025

(54) METHODS AND APPARATUS TO INCREASE ROBUSTNESS IN RADIO ACCESS NETWORK - ARTIFICIAL INTELLIGENCE (RAN-AI) LIFE-CYCLE MANAGEMENT

(71) Applicants: Shu-Ping Yeh, San Jose, CA (US); Thushara Hewavithana, Chandler, AZ (US); Jan Schreck, Scotts Valley, CA (US)

(72) Inventors: Shu-Ping Yeh, San Jose, CA (US); Thushara Hewavithana, Chandler, AZ (US); Jan Schreck, Scotts Valley, CA (US)

(21) Appl. No.: 19/243,385

(22) Filed: Jun. 19, 2025

Related U.S. Application Data
(60) Provisional application No. 63/786,738, filed on Apr. 10, 2025.

(51) Int. Cl. H04L 41/16; H04B 17/309

(52) U.S. Cl. CPC H04L 41/16; H04B 17/346

(57) ABSTRACT

A disclosed example includes identifying an event in a radio access network (RAN) based on RAN metrics data; accessing a machine learning (ML) model of the RAN; generating predictions of the ML model of the RAN based on a calibration dataset; determining uncertainty scores corresponding to the predictions of the ML model of the RAN; determining a conformity threshold based on the uncertainty scores; and updating a robustness protection layer in an inference pipeline to include the conformity threshold.

### RELATED APPLICATIONS

This patent claims the benefit of U.S. Provisional Patent Application No. 63/786,738, which was filed on Apr. 10, 2025. U.S. Provisional Patent Application No. 63/786,738 is hereby incorporated herein by reference in its entirety. Priority to U.S. Provisional Patent Application No. 63/786,738 is hereby claimed.

### BACKGROUND

Wireless network management involves monitoring performance metrics and adjusting configuration parameters of wireless communication networks to maintain operability of the wireless communication networks.

### BRIEF DESCRIPTION OF THE DRAWINGS

FIG. 1 is a block diagram of an example wireless communication network environment in which an example radio access network artificial intelligence (RAN-AI) life cycle manager (LCM) operates to increase robustness of artificial intelligence/machine learning (AI/ML) model predictions in an inference runtime pipeline of a RAN-AI system in accordance with teachings disclosed herein.

FIG. 2 is a block diagram of an example implementation of the RAN-AI LCM and the inference runtime pipeline of FIG. 1 in accordance with teachings disclosed herein.

FIG. 3 is a block diagram of an example implementation of a portion of the RAN-AI LCM of FIG. 2 to perform dynamic algorithm selection (DAS) of an optimal equalization (EQ) algorithm that decreases uncertainties of predictions of a RAN-AI model of the RAN-AI LCM in accordance with teachings disclosed herein.

FIG. 4 is a table of example results for EQ algorithm selection.

FIG. 5 is a flowchart representative of example machine-readable instructions and/or example operations that may be executed, instantiated, and/or performed by example programmable circuitry to implement the RAN-AI LCM of FIG. 2 to perform calibrations in accordance with teachings disclosed herein.

FIG. 6 is a flowchart representative of example machine-readable instructions and/or example operations that may be executed, instantiated, and/or performed by example programmable circuitry to implement the RAN-AI LCM of FIG. 2 to create new data classification labels and perform calibrations of uncertainty measures of RAN-AI models in accordance with teachings disclosed herein.

FIG. 7 is a flowchart representative of example machine-readable instructions and/or example operations that may be executed, instantiated, and/or performed by example programmable circuitry to implement the RAN-AI LCM of FIG. 2 to select an EQ algorithm that decreases uncertainties of predictions of a RAN-AI model of the RAN-AI LCM in accordance with teachings disclosed herein.

FIG. 8 is a block diagram of an example processing platform including programmable circuitry structured to execute, instantiate, and/or perform the example machine-readable instructions and/or perform the example operations disclosed herein.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine-readable instructions to implement the example processes disclosed herein) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Examples disclosed herein may be used in AI-native wireless networks (e.g., AI-Native Sixth-Generation (6G) wireless networks) to increase robustness in radio access network—artificial intelligence (RAN-AI) life-cycle management (LCM). In recent years, wireless network management has been implemented using artificial intelligence/machine learning (AI/ML) models. However, challenges in AI/ML-based solutions include improving efficiencies and performance of wireless networks and ensuring the robustness of AI/ML solutions under diverse, highly dynamic, and sometimes even adversarial conditions in wireless communications, including wireless channel variations, user mobility, traffic dynamics, and interference from neighboring cells. Examples disclosed herein provide a robustness protection controller that implements a robustness protection layer to apply conformal prediction to RAN-AI solutions. Examples disclosed herein can be used to enhance RAN-AI LCM to support parameter and model adaptation for robustness protection in the changing wireless environment.

Prior AI/ML based solutions for wireless network management retrain an ML model using recent measurements in an AI model LCM process. However, such approaches are not able to timely adapt to the changing environment due to significant delay overhead.

Examples disclosed herein provide robustness protection for RAN-AI solutions. Examples disclosed herein also provide a data analysis module in a RAN-AI life-cycle management workflow to detect data distribution shift. Examples disclosed herein also provide a calibration workflow in RAN-AI life-cycle management to support robustness protection and trigger conditions and configuration parameters for the calibration workflow. For wireless networks, examples disclosed herein provide reliable communications to improve user experiences. For example, a failure in a known RAN-AI model may result in an outage or a violation in service level agreement (SLA) or quality of service (QoS) requirements. Examples disclosed herein provide robust RAN-AI LCM solutions to substantially reduce or prevent such failures. Examples disclosed herein may be used to provide fallback approaches for RAN-AI solutions.

Examples disclosed herein can be used to adapt RAN-AI life-cycle management to use dynamic algorithm selection (DAS) of signal processing algorithms, or optimal equalization (EQ) algorithms for use by the RAN 106 to process signal data associated with wireless communications. Examples disclosed herein use robustness protection based on conformal prediction. Examples disclosed herein identify robustness issues by computing uncertainty scores that quantify the uncertainty associated with predictions of RAN-AI models. Such disclosed examples enable robust selection of signal processing algorithms, or EQ algorithms, depending on operating conditions of a RAN; triggering a switch to one or more fallback solutions (e.g., for severe out-of-distribution conditions) such as non-AI-based decision-making rules for particular RAN operating scenarios; triggering a switch to alternative RAN-AI models when predictions become unreliable; and/or performing targeted data collection, focusing resources efficiently on areas with larger uncertainty in prediction outputs of RAN-AI models.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a neural network model is used. Using a neural network model enables processing substantially real-time data based on RAN metrics to contribute in control of RAN-AI system operations. In general, machine learning models/architectures that are suitable to use in the example approaches disclosed herein will be neural network (NN). However, other types of machine learning models could additionally or alternatively be used such as deep neural network (DNN), recurrent neural network (RNN), convolutional neural network (CNN), long short term memory (LSTM), gated recurrent unit (GRU), support vector machine (SVM), etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using stochastic gradient descent. However, any other training algorithm may additionally or alternatively be used. In examples disclosed herein, training is performed until a threshold number of training epochs is satisfied or until a prediction accuracy no longer improves beyond an improvement threshold. In examples disclosed herein, training is performed offline (e.g., at a remote location such as a central facility) on a large dataset (e.g., a dataset of 100k+ samples) that covers various operating conditions/scenarios of a RAN. Training is performed using hyperparameters that control how the learning is performed (e.g., a learning rate, a number of layers to be used in the machine learning model, etc.). In examples disclosed herein, hyperparameters that control the number of layers, nodes per layer, loss function, learning rate, batch size, etc. are selected. Such hyperparameters are selected by, for example, automated scripts or a human. In some examples retraining may be performed. Such retraining may be performed in response to predictions generated by a RAN-AI model. In some examples, recalibration is performed periodically and/or based on RAN performance, AI prediction accuracy performance of a RAN-AI model, and/or data distribution shift metrics.

Training is performed using training data. In examples disclosed herein, the training data originates from RAN key performance metrics (KPMs) generated by a RAN. Because supervised training is used, the training data is labeled. Labeling is applied to the training data by a data preparation controller in a training pipeline. In some examples, the training data is pre-processed using, for example, an offline simulator to label the training data. In some examples, the training data is sub-divided into training data and validation data.

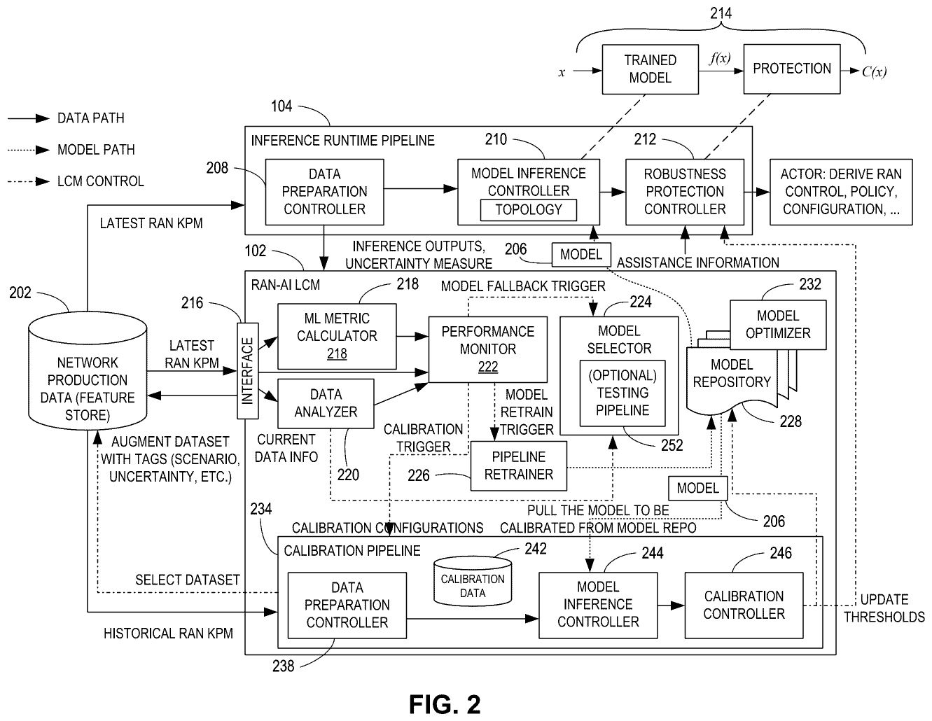

Once training is complete, the model is deployed for use as an executable construct that processes an input and provides an output based on the network of nodes and connections defined in the model. The model is stored at a model repository in a RAN-AI LCM. The model may then be executed by a model inference controller (e.g., a model inference controller 210 in an inference runtime pipeline 104 during runtime and/or a model inference controller 244 in a calibration pipeline 234 of FIG. 2 during a calibration phase).

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

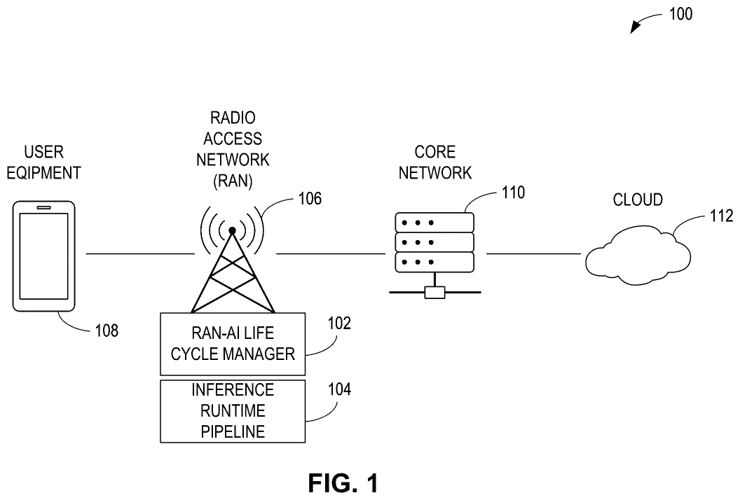

FIG. 1 is a block diagram of an example wireless communication network environment 100 in which an example radio access network artificial intelligence (RAN-AI) life cycle manager (LCM) 102 operates to increase robustness of RAN-AI model predictions in an example RAN-AI system of an example RAN 106. In the example of FIG. 1, the RAN-AI system of the RAN 106 includes the RAN-AI LCM 102 and an example inference runtime pipeline 104. In the example wireless communication network environment 100, user equipment (UE) 108 is in wireless communication with the RAN 106, the RAN 106 is in communication with an example core network 110, and the core network 110 is in communication with an example cloud 112.

The example UE 108 may be any electronic device capable of wireless communications such as a mobile phone, a tablet computing device, a laptop, a desktop computer, an Internet appliance, a network-connected vehicle, etc. The example cloud 112 stores data and/or hosts services available to be accessed by the UE 108. The example core network 110 provides the UE 108 with access to a wide area network (WAN) such as the Internet and manages network traffic between different RANs and between RANs and other network locations (e.g., network traffic between the RAN 106 and the cloud 112). The example RAN 106 includes a wireless base station to wirelessly connect to the UE 108 and other UEs. The example RAN 106 converts data between wireless communication protocols and wired communication protocols to relay information between the UE 108 and the core network 110. The example RAN-AI life cycle manager 102 is provided to improve efficiencies and performance of wireless networks by increasing robustness of AI/ML predictions under diverse, highly dynamic, and sometimes even adversarial conditions in wireless communications, including wireless channel variations, user mobility, traffic dynamics, and interference from neighboring cells.

The example inference runtime pipeline 104 receives input data, executes a RAN-AI model to generate prediction outputs based on the input data, and implements robustness protections as described below in connection with FIG. 2 to increase robustness of the RAN-AI model predictions. The RAN-AI model in the inference runtime pipeline 104 is used to control operations of the RAN 106 to manage wireless communications. For example, the RAN-AI model may receive RAN KPM input data (e.g., signal-to-noise ratio (SNR), signal-to-interference-plus-noise ratio (SINR), radio bearer (RB) utilization, number of spatial streams to be transmitted with multiple antennas, UE mobility, etc.) generated by the RAN 104 and generate output predictions corresponding to parameters of the RAN 106 that may be used to update RAN control parameters, RAN operating policies, RAN configurations, etc. associated with the RAN 106 maintaining an expected quality of service (QOS) for wireless communications.

FIG. 2 is a block diagram of an example implementation of the RAN-AI LCM 102 of FIG. 1. The example RAN-AI LCM 102 is in communication with an example network production data store 202 and the example inference runtime pipeline 104. The RAN-AI LCM 102 and the example inference runtime pipeline 104 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSC), etc. Additionally or alternatively, the RAN-AI LCM 102 and the example inference runtime pipeline 104 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example network production data store 202 (e.g., a feature store) is to store current (e.g., substantially real time) and historical RAN key performance metrics (KPM) data. The RAN KPM data can be used as training data and/or calibration data and is updated periodically based on the latest RAN operating measures generated by the RAN 106. In examples disclosed herein, current RAN KPM data is substantially real-time data accessible in the network production data store 202 as it is received from one or more RAN KPM generators of the RAN 106. In examples disclosed herein, historical RAN KPM data is previously generated data over the past hour(s), day(s), etc. The RAN KPM data corresponds to, for example, signal-to-noise ratio (SNR), signal-to-interference-plus-noise ratio (SINR), radio bearer (RB) utilization, number of spatial streams to be transmitted with multiple antennas, UE mobility, etc. The example inference runtime pipeline 104 is provided to use RAN-AI models (e.g., ML models) to generate predictions based on input data. In the example of FIG. 1, input data to the inference runtime pipeline 104 is most recent RAN KPM data from the network production data store 202.

The example inference runtime pipeline 104 includes an example data preparation controller 208, an example model inference controller 210, and an example robustness protection controller 212. The example data preparation controller 208 prepares KPM data from the network production data store 202 to be input data for an example RAN-AI model 206 run by the model inference controller 210. The example model inference controller 210 accesses the RAN-AI model 206 (e.g., from the model repository 228 of the RAN-AI LCM 102) and feeds input data from the data preparation controller 208 into the RAN-AI model 206 to generate prediction outputs based on the topology of the RAN-AI model 206 and the input data.

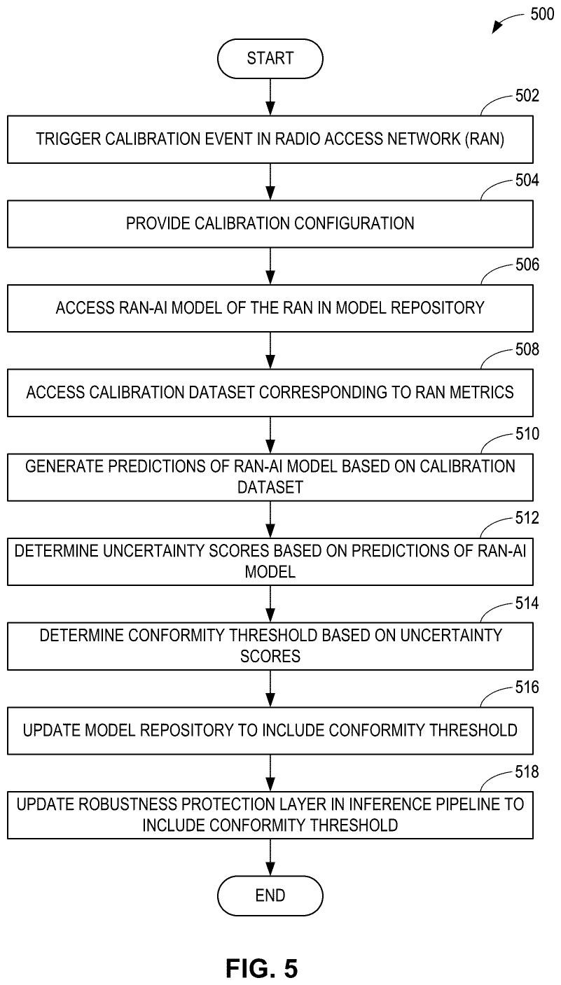

In some examples, the inference runtime pipeline 104 is inference runtime pipeline circuitry instantiated by programmable circuitry executing inference runtime pipeline instructions and/or configured to perform operations such as those represented by one or more of the flowcharts of FIGS. 5-7.

In some examples, the data preparation controller 208 is data preparation controller circuitry instantiated by programmable circuitry executing data preparation controller instructions and/or configured to perform operations such as those represented by one or more of the flowcharts of FIGS. 5-7.

In some examples, the model inference controller 210 is model inference controller circuitry instantiated by programmable circuitry executing model inference controller instructions and/or configured to perform operations such as those represented by one or more of the flowcharts of FIGS. 5-7.

In some examples, the robustness protection controller 212 is robustness protection controller circuitry instantiated by programmable circuitry executing robustness protection controller instructions and/or configured to perform operations such as those represented by one or more of the flowcharts of FIGS. 5-7.

### Robustness Protection for RAN-AI

The example robustness protection controller 212 implements a robustness protection layer in the inference runtime pipeline 104 to improve robustness for RAN-AI models. In the example of FIG. 2, the example robustness protection controller 212 is located after the RAN-AI model 206 in the model inference controller 210. For example, the robustness protection controller 212 is to detect prediction inaccuracies in predictions generated by the RAN-AI model 206 instantiated by the model inference controller 210. Based on outputs from the RAN-AI model 206, the example robustness protection controller 212 helps derive a more conservative choice of action. For example, the robustness protection controller 212 makes decisions on whether to take corrective actions related to recalibration, fallback model selection, and/or retraining based on predictions generated by the RAN-AI model 206 in the model inference controller 210 using recent RAN KPM data from the network production data store 202.

To increase robustness using the robustness protection controller 212, the RAN-AI model 206 produces uncertainty measures in its output. For example, in classification models, the last layer of a softmax output can be interpreted as the probability of a class being the correct choice (e.g., how certain the RAN-AI model 206 thinks this class should be chosen). Other examples include using an RAN-AI model to estimate the mean and variance of a target, a RAN-AI model for quantile regression, etc. However, when there is a data distribution shift in a training dataset and actual incoming data, examples disclosed herein calibrate the uncertainty measure of the RAN-AI model 206. The example robustness protection controller 212 incorporates calibration results when producing a conservative choice of actions that are selectable to affect (e.g., control) operation of the RAN 106.

Based on the uncertainty measure from the RAN-AI model 206, the example robustness protection controller 212 may choose a more conservative action. For example, with quantile regression for traffic load prediction, the robustness protection controller 212 can choose to output a conservative quantile (e.g., worst 90%) as a prediction result to ensure the network can safely serve an incoming traffic load 90% of the time. The output of the example robustness protection controller 212 may be used by an actor (e.g., a device taking action based on the output) to derive RAN control, RAN policy, RAN configuration, or any other aspect corresponding to the RAN 106.

### Robustness Protection Through Conformal Prediction

In examples disclosed herein, the robustness protection controller 212 may be used to provide robustness protection through conformal prediction. Conformal prediction enhances AI robustness by generating prediction sets C(x) instead of point predictions f(x) as shown in the example conformal prediction sequence 214 of FIG. 2. These prediction sets are designed to include the true value with high probability. When there is higher uncertainty, the prediction sets are larger, reflecting the increased range within which the true value is likely to be. This method leverages the estimated uncertainty associated with a model's outputs to provide protection. By identifying less reliable predictions, the example robustness protection controller 212 can minimize risk in performance degradation in downstream tasks and support informed decision-making.

For example, in a classification task, instead of predicting a single class label, the robustness protection controller 212 can use conformal prediction to determine a set of possible labels while providing a high probability that the true label is included within this set. Similarly, in regression tasks, the example robustness protection controller 212 can use conformal prediction to provide prediction intervals that account for the uncertainty in a RAN-AI model's output, making the predictions more reliable and robust against unexpected variations in input data.

Conformal prediction enhances the reliability of predictive algorithms by providing rigorous statistical guarantees. Unlike traditional machine learning methods that output point predictions without explicit uncertainty quantification, conformal prediction ensures that predictions come with valid and well-calibrated confidence measures. This framework is highly versatile, as it can be applied to any machine learning model, including both regression and classification tasks. Conformal prediction improves model resilience to distributional shifts, ensuring that predictions remain reliable even when input data distributions change over time.

In examples disclosed herein, the robustness protection controller 212 increases the effectiveness of conformal prediction by using a calibration process to ensure applicability of the conformal prediction in real-world scenarios (e.g., operating scenarios of the RAN 106). Such proper calibration maintains the reliability of uncertainty estimates, which can be particularly challenging in highly dynamic environments where input data distributions frequently shift. In examples disclosed herein, recalibration strategies are implemented to maintain the validity of predictions over time.

### RAN-AI Life Cycle Management (LCM)

The example RAN-AI LCM 102 includes an example interface 216, an example ML metric calculator 218, an example data analyzer 220, an example performance monitor 222, an example model selector 224, an example pipeline retrainer 226, an example model repository 228, an example model optimizer 232, and an example calibration pipeline 234. The example calibration pipeline 234 includes an example data preparation controller 238, an example calibration dataset store 242, an example model inference controller 244, and an example calibration controller 246.

In some examples, the interface 216 is interface circuitry instantiated by programmable circuitry executing interface instructions and/or configured to perform operations such as those represented by one or more of the flowcharts of FIGS. 5-7.

In some examples, the ML metric calculator 218 is ML metric calculator circuitry instantiated by programmable circuitry executing ML metric calculator instructions and/or configured to perform operations such as those represented by one or more of the flowcharts of FIGS. 5-7.

In some examples, the data analyzer 220 is data analyzer circuitry instantiated by programmable circuitry executing data analyzer instructions and/or configured to perform operations such as those represented by one or more of the flowcharts of FIGS. 5-7.

In some examples, the performance monitor 222 is performance monitor circuitry instantiated by programmable circuitry executing performance monitor instructions and/or configured to perform operations such as those represented by one or more of the flowcharts of FIGS. 5-7.

In some examples, the model selector 224 is model selector circuitry instantiated by programmable circuitry executing model selector instructions and/or configured to perform operations such as those represented by one or more of the flowcharts of FIGS. 5-7.

In some examples, the pipeline retrainer 226 is pipeline retrainer circuitry instantiated by programmable circuitry executing pipeline retrainer instructions and/or configured to perform operations such as those represented by one or more of the flowcharts of FIGS. 5-7.

In some examples, the model optimizer 232 is model optimizer circuitry instantiated by programmable circuitry executing model optimizer instructions and/or configured to perform operations such as those represented by one or more of the flowcharts of FIGS. 5-7.

In some examples, the calibration pipeline 234 is calibration pipeline circuitry instantiated by programmable circuitry executing calibration pipeline instructions and/or configured to perform operations such as those represented by one or more of the flowcharts of FIGS. 5-7.

In some examples, the data preparation controller 238 is data preparation controller circuitry instantiated by programmable circuitry executing data preparation controller instructions and/or configured to perform operations such as those represented by one or more of the flowcharts of FIGS. 5-7.

In some examples, the model inference controller 244 is model inference controller circuitry instantiated by programmable circuitry executing model inference controller instructions and/or configured to perform operations such as those represented by one or more of the flowcharts of FIGS. 5-7.

In some examples, the calibration controller 246 is calibration controller circuitry instantiated by programmable circuitry executing calibration controller instructions and/or configured to perform operations such as those represented by one or more of the flowcharts of FIGS. 5-7.

The example interface 216 is provided to access RAN KPM data in the network production data store 202. For example, the interface 216 can access the most recently collected RAN KPM data (e.g., substantially real-time RAN KPM data) so that the RAN-AI LCM 102 makes decisions based on the most recently observed behavior and/or data distribution of the RAN 106. Given the dynamic nature of wireless environments, a RAN-AI model (e.g., an ML model) from the model repository 228 may not work well in the model inference controller 210 if incoming KPM data from the network production data store 202 starts to deviate from the distribution of an original training dataset. Therefore, examples disclosed herein monitor and retrain a RAN-AI model in the model repository 228 based on data distribution shift. In some examples, the interface 216 can also augment RAN KPM data in the network production data store 202 with corresponding tags (e.g., RAN operating scenarios, uncertainty measures, etc.) from the RAN-AI LCM 102.

The example RAN-AI LCM 102 includes the example performance monitor 222 to make decisions. The example performance monitor 222 continuously monitors RAN measurements, ML performance metrics, and data statistics to determine whether to trigger a model retrain event, a model fallback event, or an uncertainty calibration event.

The example RAN-AI LCM 102 is provided with the example ML metric calculator 218 to check the RAN KPM measurements from the network production data store 202 to calculate an accuracy from ground truth. In addition, the example ML metric calculator 218 calculates other AI metrics such as reward value for reinforcement learning. The ML metric calculator 218 can use the accuracy results to calculate uncertainty metrics.

The example data analyzer 220 is provided to extract key features from the RAN KPM data from the network production data store 202 and provide statistics reports or summary data information to other modules. Example key features include SNR magnitudes. For example, the data analyzer 220 may extract high SNR region features, mid SNR region features, and low SNR region features. In other examples, any other suitable features may be extracted from the RAN KPM data and used with examples disclosed herein.

In examples disclosed herein, ‘model retrain’ events, ‘model fallback’ events, or ‘calibration’ events can be triggered periodically and/or based on RAN performance, AI prediction accuracy performance of a RAN-AI model, and/or data distribution shift metrics.

The example RAN-AI LCM 102 is provided with the example model selector 224 to make decisions on which RAN-AI model (e.g., ML model) to select from the model repository 228. For example, based on information about RAN KPM data provided by the data analyzer, the model selector 224 checks if there are new or existing RAN-AI models with satisfactory performance for a test dataset matching the property of the incoming RAN KPM data. When there are more than one RAN-AI model in the model repository 228 with satisfactory performance, the example model selector 224 can select the RAN-AI model based on, for example, a configurable complexity and performance trade-off target. If the incoming RAN KPM data from the network production data store 202 is different from past test datasets, then the example model selector 224 can select a subset of RAN-AI models and run an example testing pipeline 252 for those RAN-AI models with a new test dataset matching the property of incoming RAN KPM data. If there is no safe fallback RAN-AI model with satisfactory performance for incoming RAN KPM data statistics, the example performance monitor 222 can send ‘assistance information’ to the inference pipeline 104 to indicate that RAN control should fallback to a safe baseline algorithm instead of using an ML-based algorithm.

### Data Analysis Module in RAN-AI Life Cycle Management

Wireless communication systems operate in diverse environments under highly dynamic wireless channel and traffic conditions. To address potential issues of incoming data statistics of current operating conditions diverging away from the training scenarios, the example data analyzer 220 collects statistics and/or extracts key features from the incoming RAN KPM data to detect data distribution shift. In some examples, the data analyzer 220 can cause updates of the RAN-AI model 206 over time based on detected data distribution shifts.

The example data analyzer 220 may generate data statistic reports for RAN KPMs. In some examples, target RAN metrics (or other metrics that impact the RAN-AI model performance) can be inputs to the RAN-AI models in the model repository 228. Examples of RAN KPMs include signal-to-noise ratio (SNR), signal-to-interference-plus-noise ratio (SINR), resource block (RB) utilization, number of spatial streams to be transmitted with multiple antennas, user equipment (UE) mobility, etc. The report can include mean, variance, and histogram of target RAN KPMs. Example types of data statistic reports include: long-term overall statistics reports, scenario-specific statistics reports, and short-term statistics reports for recent incoming RAN KPM data. In examples disclosed herein, scenario-specific statistics include day-time scenario and night-time scenario statistics that can be collected separately. Scenarios can also be based on RAN metrics (e.g., SNR statistics for high-load and low-load scenarios can be collected separately). Scenarios can also be based on data features. For example, if there is a feature extraction model that can distinguish high-mobility and low-mobility users, their statistics can be calculated separately.

The example data analyzer 220 may also perform feature extraction from RAN KPM measurements. For example, additional RAN-AI models can be developed to extract representative features or statistical features from the RAN KPM dataset. Long-term, scenario-specific and short-term results for the features can be collected and stored in the network production data store 202 for use by the example data analyzer 220 to perform distribution shift detection.

In examples disclosed herein, the example data analyzer 220 performs detection of input data distribution shift by comparing short-term statistics/features from the RAN KPM input data with statistics/features of a training dataset that was used to train the RAN-AI model 206, and measuring the distribution difference based on those comparisons. For example, the data analyzer 220 may compare the difference based on histograms of target RAN metrics and histograms of the training dataset.

The example data analyzer 220 may also create data class labels of RAN KPM input data. For example, by creating data class labels based on feature extractions, the data analyzer 220 may identify new representative dataset scenarios in the RAN KPM input data. For new dataset scenarios, the example data analyzer 220 may create new data class labels and share the new data class labels with the model selector 224. The example data analyzer 220 also updates the new data class labels in association with corresponding RAN KPM data stored in the network production data store 202. The new data labels can be used to specify training datasets, validation datasets, testing datasets, and/or calibration datasets in training and/or calibration processes.

### Calibration Pipeline in RAN-AI Life Cycle Management

For robustness protection mechanisms relying on uncertainty quantification, the example RAN-AI LCM 102 is provided with the example calibration pipeline 234 to quickly calibrate an uncertainty measure of a RAN-AI model from recent incoming RAN KPM data and then update robustness protection parameters in the robustness protection controller 212 of the inference runtime pipeline 104. Example robustness protection parameters include a conformity threshold for conformity prediction protection and uncertainty adjustment parameters based on a calibration. The example robustness protection controller 212 uses these robustness protection parameters to increase the robustness of output predictions corresponding to parameters generated by a RAN-AI model 206 executed by the model inference controller 210. By increasing their robustness, such output predictions have improved accuracies so that RAN control parameters, RAN operating policies, RAN configurations, etc. can be derived based on those predictions for use by the RAN 106 to maintain an expected quality of service (QoS) for wireless communications.

The example performance monitor 222 monitors RAN performance of the RAN 106, AI performance of a RAN-AI model 206, and data distributions of the RAN KPM input data from the network production data store 202. The example performance monitor 222 can trigger a calibration in the calibration pipeline 234 periodically or when a RAN performance of the RAN 106, an AI prediction accuracy performance of a RAN-AI model 206, and/or a data distribution shift metric corresponding to the RAN KPM input data satisfies (e.g., exceeds or is below) a threshold.

To perform periodic calibration triggering of the calibration pipeline 234, a periodicity at which the example performance monitor 222 triggers the calibration pipeline 234 can be significantly shorter than triggering the pipeline retrainer 226 to retrain a RAN-AI model 206. This is because a compute overhead and an amount of data required to calibrate an uncertainty measure of the RAN-AI model 206 is significantly smaller than retraining the RAN-AI model 206.

To perform threshold-based calibration triggering of the calibration pipeline 234, example triggering threshold metrics that can be used by the performance monitor 222 include uncertainty measures, a calibration error, an average size of conformal set, data distribution shift estimates, RAN performance metrics (e.g., packet error rates, number of retransmission requests, etc.). In some examples, the performance monitor 222 triggers the calibration based on analyses of features extracted by the data analyzer 220 from the RAN KPM data. For example, the data analyzer 220 and/or the performance monitor 222 may analyze incoming SNR feature data from the RAN KPM data. If the RAN-AI model 206 was trained on low SNR region and mid SNR region features, and the data analyzer 220 and/or the performance monitor 222 detect(s) feature data in the high SNR region for newly collected RAN KPM data, the performance monitor 222 triggers a calibration to cause the calibration controller 246 to calculate a conformity threshold (e.g., a conformal prediction protection threshold) for the high SNR data. The reason for doing this is that the RAN-AI model 206 trained on low/mid SNR region features may not generate sufficiently accurate predictions based on input RAN KPM data that has shifted by including high SNR region features. The calibration of the RAN-AI model 206 based on the high SNR region features increases the accuracy of predictions generated by the re-calibrated RAN-AI model 206 when it encounters subsequent input RAN KPM data having high SNR region features. Although examples disclosed herein are described as the performance monitor 222 triggering calibrations, in alternative example implementations, the data analyzer 220 may perform the analyses described herein as being performed by the performance monitor 222 and may trigger calibrations based on those analyses. In addition, although the above example is based on the RAN-AI model 206 being trained on SNR magnitude features, the RAN-AI model 206 may be trained based on any other suitable types of features from RAN KPM data. Accordingly, calibration triggers may be based on analyses of feature data corresponding to such other types of features.

When the example performance monitor 222 determines that it should trigger the calibration pipeline 234, the performance monitor 222 sends calibration trigger signaling with calibration configuration information to the calibration pipeline 234. Example calibration configuration information can specify an identifier or name of a RAN-AI model 206 in the model repository 228 to be calibrated, a data source for calibration, a type of RAN KPM data to use for calibration (e.g., current RAN KPM data, historical RAN KPM data collected during last two hours, historical RAN KPM data collected during current time frame yesterday, etc.), a type of robustness protection, and/or robustness-protection related configuration information. In examples disclosed herein, a data source for calibration includes the data label for historical RAN KPM data from the network production data store 202 to be used for calibration (e.g., day-time data, night-time data, etc.). In examples disclosed herein, an example type of robustness protection includes conformal prediction. In examples disclosed herein, an example of robustness-protection related configuration information includes target quantile configuration information for conformal prediction.

After the example calibration pipeline 234 finishes calibrating a RAN-Al model 206, the calibration pipeline 234 sends parameters related to robustness protection to the inference runtime pipeline 104 as assistance information and saves those parameters back to the model repository 228 in association with the calibrated RAN-AI model 206. Example contents of assistance information from the calibration pipeline include a conformity threshold for conformity prediction protection and uncertainty adjustment parameters based on the calibration.

An example of a calibration workflow of the calibration pipeline 234 described below is based on the robustness protection mode referred to as “conformal prediction”. However, other types of robustness protection may be used in connection with examples disclosed herein. In examples disclosed herein, the following operations may be used to perform calibration of the robustness protection controller 212 for conformal prediction.

The example performance monitor 222 sends a calibration trigger signal and provides calibration configuration information, including a target quantile 1−α, to the calibration pipeline 234.

The example model inference controller 244 pulls or accesses a RAN-AI model (e.g., the RAN-AI model 206) that is the subject of the calibration from the model repository 228.

The example data preparation controller 238 accesses the network production data store 202 (e.g., a feature store) to load the calibration dataset 242 (e.g., calibration dataset [symbol] ={(xᵢ, yᵢ)}_{i=1, . . . , n}). In some examples, the data preparation controller 238 access the network production data store 202 via the interface 216. In some examples, the calibration dataset 242 is smaller than the training dataset that was originally used to train the RAN-AI model 206.

The example model inference controller 244 runs the RAN-AI model 206 based on the calibration dataset 242 to generate predicted probabilities based on the calibration dataset 242.

The example calibration controller 246 computes uncertainty scores s(xᵢ, yᵢ)=1−f_{y}_{ᵢ}(xᵢ), with (xᵢ, yᵢ)∈ [symbol] , based on the RAN-AI model's predicted probabilities, where f_{y}(x) is the RAN-AI model predicted probability of class y with input x. The example calibration controller 246 also computes a conformity threshold τ=τ( [symbol] , α), which is a function of the configured confidence level 1−α (e.g., a target quantile) and the calibration dataset: (xᵢ, yᵢ)∈ [symbol] . The conformity threshold is a cutoff value above which predictions are considered uncertain. The conformity threshold can be used by the example robustness protection controller 212 to exclude one or more predictions (e.g., τ( [symbol] , α)=(1−α)-th quantile of {s(xᵢ, yᵢ) [symbol] ) from incoming substantially real-time RAN KPM data (e.g., from the network production data store 202) in the inference runtime pipeline 104 when it/they exceed(s) the conformity threshold (e.g., the cutoff value).

The example calibration controller 246 updates a conformity threshold (τ) in the model repository 228 and in the robustness protection controller 212 in the inference runtime pipeline 104.

### RAN-AI Model Complexity Optimization

Examples disclosed herein may be used to optimize of a model size of a RAN-AI model (e.g., an ML model). For example, the model optimizer 232 may be used to reduce complexity of the RAN-AI model (e.g., the RAN-AI model 206) by strategically narrowing the parameter space over which the RAN-AI model is trained.

The example model optimizer 232 may be used to generate a focused parameter space by concentrating the parameter space on a high percentage of scenarios (e.g., 99%) that may be encountered by the RAN 106 during operation. For example, the model optimizer 232 may select parameters of a RAN-AI model (e.g., the RAN-AI model 206) that can be applied to multiple RAN operating scenarios. Through such a focused parameter space, the example pipeline retrainer 226 can train a smaller, more efficient RAN-AI model. This focused approach ensures that the RAN-AI model 206 performs optimally for the majority of cases, reducing computational requirements and improving efficiency of the RAN-AI model 206. For the remaining 1% of RAN operating scenarios of the RAN 106, which are considered outliers, the example RAN-AI LCM 102 can use a larger RAN-AI model from the model repository 228 to accommodate the wider parameter space introduced by those RAN operating scenarios.

In some examples, the RAN-AI LCM 102 can provide a fallback mechanism to handle the 1% of RAN operating scenarios considered outliers. For example, based on input from the ML metric calculator 218 and the data analyzer 220, the performance monitor 222 can identify less reliable predictions, which are likely to be outliers. When an outlier is detected, the example performance monitor 222 can trigger a model fallback or initiate a recalibration of the robustness protection controller 212. In response to a model fallback trigger from the performance monitor 222, the example model selector 224 selects a different RAN-AI model from the model repository 228 that is more suitable for the RAN operating scenario. For example, the model selector 224 may receive information about current RAN KPM data (e.g., substantially real-time RAN KPM data) from the data analyzer 220 that describes the RAN operating scenario of the RAN 106 and use the current RAN KPM data to select a RAN-AI model suitable for the RAN operating scenario. In some examples, the model selector 224 may use the testing pipeline 252 to test candidate RAN-AI models in the model repository 228 for suitableness based on the current RAN KPM data. For example, the model selector 224 can select a RAN-AI model that outputs the predictions that are more accurate than other RAN-AI models in the model repository 228.

In response to a calibration trigger from the performance monitor 222, the example calibration pipeline 234 re-calibrates a robustness protection layer implemented by the robustness protection controller 212 (e.g., updates robustness protection parameters of the robustness protection controller 212 based on calibrating the uncertainty measure of the RAN-AI model 206), as described above. Implementations of model fallback and calibration triggering may be modified for different use cases. For example, selection of a different model from the model repository 228 or re-calibration of the robustness protection controller 212 may be based on the particular RAN operating scenario of the RAN 106.

This strategy offers two example benefits. A first example benefit is efficiency. For example, by focusing on the most common scenarios, the ML model remains compact and efficient. A second example benefit is system robustness. For example, the fallback mechanism ensures that the system can handle outliers without compromising overall performance.

### Dynamic Algorithm Selection

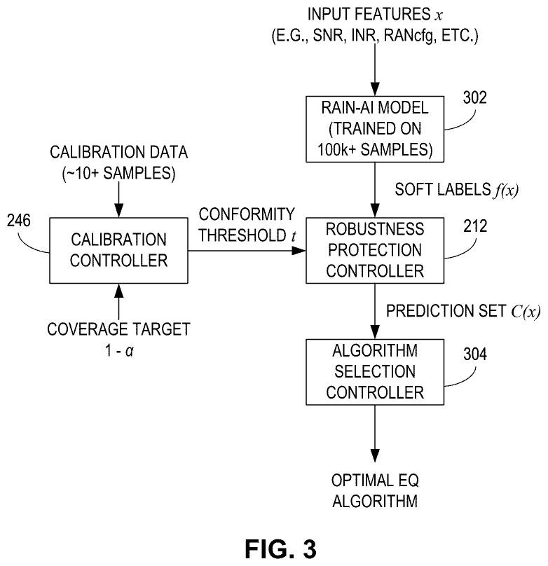

FIG. 3 is a block diagram of an example implementation of a portion of the RAN-AI LCM 102 of FIG. 2 to perform dynamic algorithm selection of an optimal equalization (EQ) algorithm that decrease uncertainties of predictions of a RAN-AI model of the RAN-AI LCM 102. The example RAN-AI LCM 102 implements dynamic algorithm selection (DAS) to enhance RAN performance by dynamically switching between different signal processing algorithms in substantially real time. In examples disclosed herein, signal processing algorithms, or EQ algorithms, are used by the RAN 106 to process incoming signals associated with wireless communications and corresponding to RAN KPMs stored in the network production data store 202. The RAN-AI LCM 102 implements this dynamic adaptation to optimize network performance of the RAN 106 and minimize computational complexity across diverse operating conditions of the RAN 106.

To implement DAS, the example RAN-AI LCM 102 trains an ML classifier based on RAN performance data (e.g., the RAN KPM data in the network production data store 202), RAN configurations, and algorithm specifications (e.g., limits, coefficients, ranges, etc. of an EQ algorithm). Collecting and labeling datasets for ML model training are computationally intensive tasks, making frequent dataset updates and model retraining challenging. To overcome such challenges associated with shifts in data distributions, the example RAN-AI LCM 102 is configured to perform DAS as a more adaptive solution than prior techniques to frequently changing operating conditions of the RAN 106.

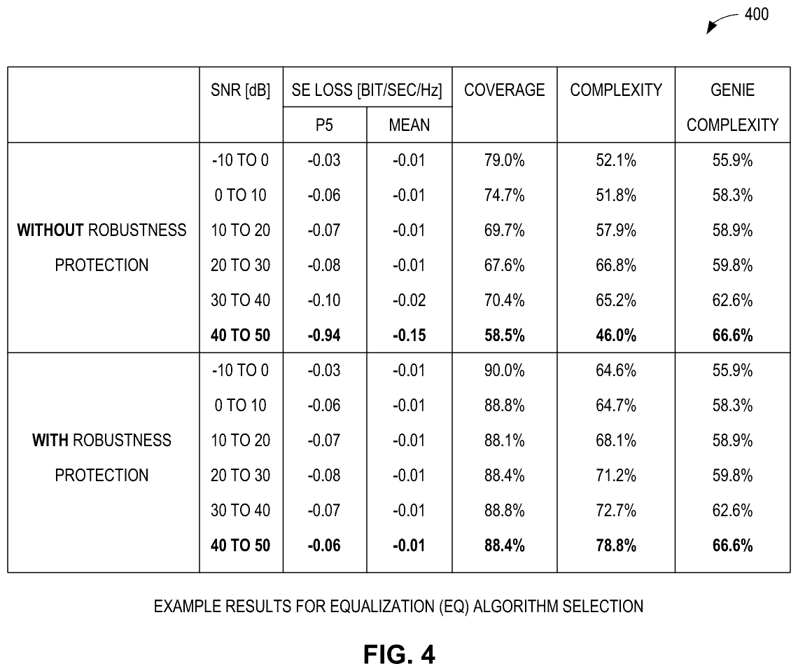

The example of FIG. 4 represents selection of an optimal EQ algorithm in a physical layer of the RAN 106. The example of FIG. 4 depicts a general flow of algorithm selection with robustness protection based on conformal prediction.

The selection of the EQ algorithm in the example of FIG. 4 is based on a pretrained RAN-AI model 302 that utilizes input features such as signal-to-noise ratio (SNR), interference-to-noise ratio (INR), and/or RAN configuration (RANcfg) data. This RAN-AI model 302 is trained offline on a large dataset (e.g., a dataset of 100k+ samples) that covers various operating conditions. To ensure robustness, the calibration controller 246 calibrates the robustness protection controller 212 based on a coverage target quantile (1−α) using a small number of data samples collected under current RAN operating conditions of the RAN 106. This calibration process establishes the conformity threshold (τ). The calibration controller 212 provides the conformity threshold (τ) to the robustness protection controller 212

Given the input features x, the example RAN-AI model 302 (e.g., selected from the model repository 228 of FIG. 2) generates soft labels f_{y}(x) for each candidate EQ algorithm y. The example RAN-AI model 302 provides the soft labels f_{y}(x) to the robustness protection controller 212. The example robustness protection controller 212 then computes uncertainty scores s(x,y)=1−f_{y}(x) and determines a prediction set C(x)={y|s(x,y)<τ}. The example robustness protection controller 212 provides the prediction set C(x) to an example algorithm selection controller 304 so that the final EQ algorithm selection can be made downstream based on the prediction set C(x) and additional EQ algorithm information (e.g., performance data and RAN KPM complexity metrics from the network production data store 202). Selectable EQ algorithms may be of different complexities (e.g., low-complexity algorithms or high-complexity algorithms that use relatively more resources than low-complexity algorithms). Example EQ algorithms include matched filter, zero-forcing, minimum mean square error, minimum mean square error with interference rejection combining, maximum likelihood detection, and sphere decoding. Other EQ algorithms may additionally or alternatively be used. In some examples, the algorithm selection controller 304 is part of the inference runtime pipeline 104 of FIG. 2. In other examples, the algorithm selection controller 304 is separate from the inference runtime pipeline 104. In any case, the example DAS of FIG. 4 provides a well-defined hierarchy of the EQ algorithms selectable over time for different RAN operating scenarios, which allows selection of an EQ algorithm from C(x) that increases the stability of wireless performance of the RAN 106.

FIG. 4 is a table 400 of example results for EQ algorithm selection. The example results of FIG. 4 are based on the following performance metrics:
SE Loss: Spectral efficiency (SE) loss is measured against an ideal predictor (genie) that selects the EQ algorithm with the best performance-complexity trade-off. Smaller values indicate better performance.
Coverage: The probability that the true label is included in the prediction set. Higher values are better.
Complexity: The normalized computational complexity, with the most complex algorithm having a complexity of 100%. Lower values are better.
Genie Complexity: The normalized complexity of the perfect predictor. Lower values are better.

The RAN-AI model corresponding to the results of FIG. 4 was trained on an SNR range from −10 to 30 decibels (dB). Consequently, performance without robustness protection drops significantly for SNR>30 dB. In some examples, the robustness protection controller 212 of FIGS. 2 and 3 employs conformal prediction and is calibrated on 100 samples to achieve a RAN operating scenarios coverage of 90%. This robustness protection of the example robustness protection controller 212 enables the RAN 106 to maintain overall wireless performance even for out-of-distribution SNR>30 dB. As shown in the results of FIG. 4, the robustness protection controller 212 achieves a coverage close to its target of 90%.

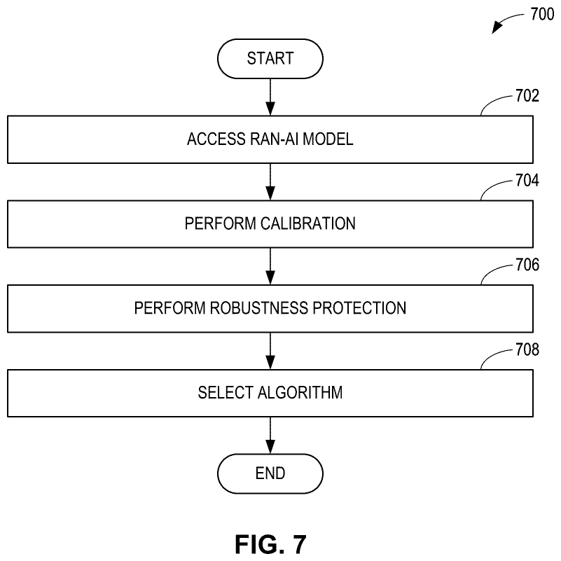

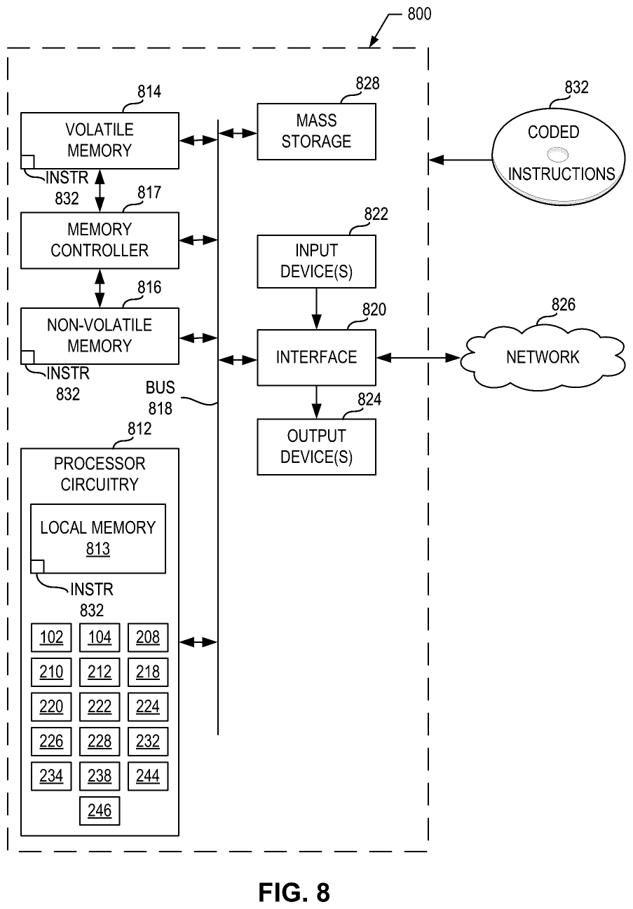

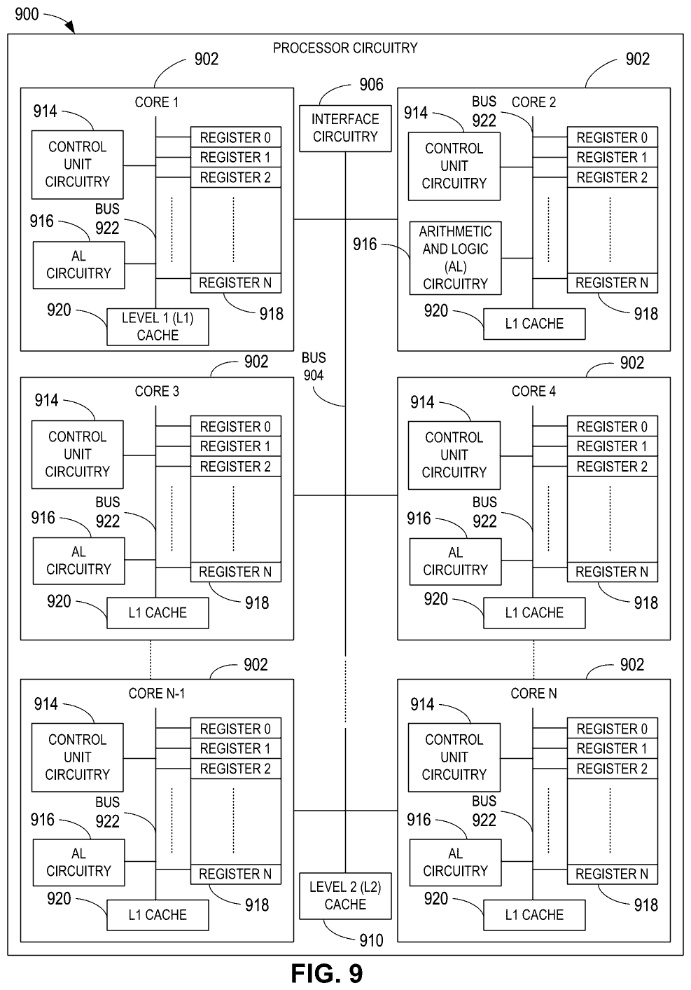

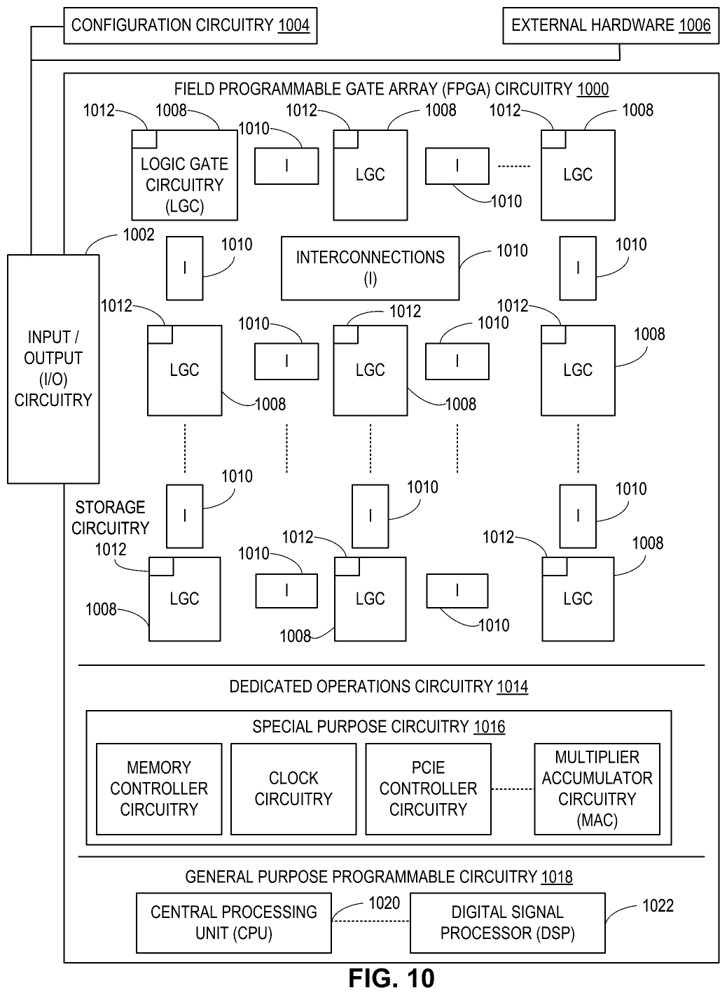

In some examples, the inference runtime pipeline 104 includes means for increasing robustness of AI/ML model predictions. For example, the means for increasing robustness may be implemented by the robustness protection controller 212. In some examples, the robustness protection controller 212 may be instantiated by programmable circuitry such as the example programmable circuitry 812 of FIG. 8. For instance, the robustness protection controller 212 may be instantiated by the example microprocessor 900 of FIG. 9 executing machine executable instructions such as those implemented by at least block 706 of FIG. 7. In some examples, the robustness protection controller 212 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the robustness protection controller 212 may be instantiated by any other combination of hardware, software, and/or firmware. For example, the robustness protection controller 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

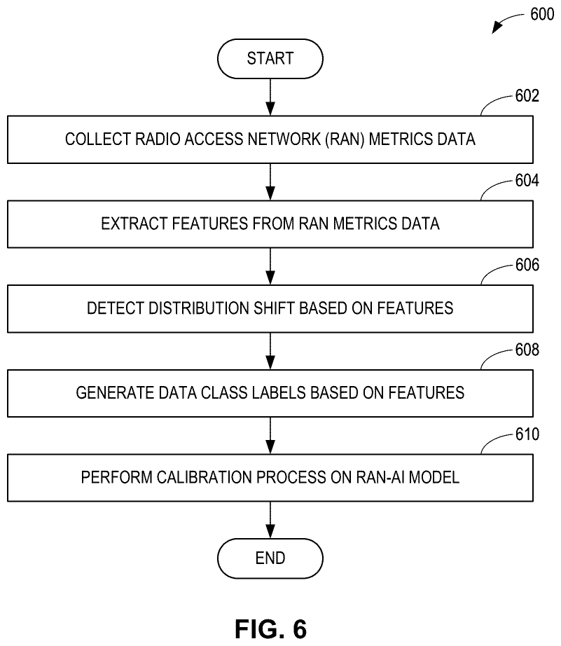

In some examples, the RAN-AI LCM 102 includes means for accessing data. For example, the means for accessing data may be implemented by the interface 216. In some examples, the interface 216 may be instantiated by programmable circuitry such as the example programmable circuitry 812 of FIG. 8. For instance, the interface 216 may be instantiated by the example microprocessor 900 of FIG. 9 executing machine executable instructions such as those implemented by at least block 602 of FIG. 6. In some examples, the interface 216 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the interface 216 may be instantiated by any other combination of hardware, software, and/or firmware. For example, the interface 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the RAN-AI LCM 102 includes means for analyzing data. For example, the means for analyzing data may be implemented by the data analyzer 220. In some examples, the data analyzer 220 may be instantiated by programmable circuitry such as the example programmable circuitry 812 of FIG. 8. For instance, the data analyzer 220 may be instantiated by the example microprocessor 900 of FIG. 9 executing machine executable instructions such as those implemented by at least blocks 604, 606, 608 of FIG. 6. In some examples, the data analyzer 220 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the data analyzer 220 may be instantiated by any other combination of hardware, software, and/or firmware. For example, the data analyzer 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the RAN-AI LCM 102 includes means for monitoring performance. For example, the means for monitoring performance may be implemented by the performance monitor 222. In some examples, the performance monitor 222 may be instantiated by programmable circuitry such as the example programmable circuitry 812 of FIG. 8. For instance, the performance monitor 222 may be instantiated by the example microprocessor 900 of FIG. 9 executing machine executable instructions such as those implemented by at least blocks 502, 504 of FIG. 5. In some examples, the performance monitor 222 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the performance monitor 222 may be instantiated by any other combination of hardware, software, and/or firmware. For example, the performance monitor 222 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the RAN-AI LCM 102 includes means for selecting models. For example, the means for selecting models may be implemented by the model selector 224. In some examples, the model selector 224 may be instantiated by programmable circuitry such as the example programmable circuitry 812 of FIG. 8. For instance, the model selector 224 may be instantiated by the example microprocessor 900 of FIG. 9 executing machine executable instructions such as those implemented by at least block 506 of FIG. 5. In some examples, the model selector 224 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the model selector 224 may be instantiated by any other combination of hardware, software, and/or firmware. For example, the model selector 224 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the RAN-AI LCM 102 includes means for preparing data. For example, the means for preparing data may be implemented by the data preparation controller 238. In some examples, the data preparation controller 238 may be instantiated by programmable circuitry such as the example programmable circuitry 812 of FIG. 8. For instance, the data preparation controller 238 may be instantiated by the example microprocessor 900 of FIG. 9 executing machine executable instructions such as those implemented by at least block 508 of FIG. 5. In some examples, the data preparation controller 238 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the data preparation controller 238 may be instantiated by any other combination of hardware, software, and/or firmware. For example, the data preparation controller 238 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the RAN-AI LCM 102 includes means for executing a model. For example, the means for executing a model may be implemented by the model inference controller 244. In some examples, the model inference controller 244 may be instantiated by programmable circuitry such as the example programmable circuitry 812 of FIG. 8. For instance, the model inference controller 244 may be instantiated by the example microprocessor 900 of FIG. 9 executing machine executable instructions such as those implemented by at least block 510 of FIG. 5 and block 702 of FIG. 7. In some examples, the model inference controller 244 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the model inference controller 244 may be instantiated by any other combination of hardware, software, and/or firmware. For example, the model inference controller 244 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the RAN-AI LCM 102 includes means for calibrating. For example, the means for calibrating may be implemented by the calibration controller 246. In some examples, the calibration controller 246 may be instantiated by programmable circuitry such as the example programmable circuitry 812 of FIG. 8. For instance, the calibration controller 246 may be instantiated by the example microprocessor 900 of FIG. 9 executing machine executable instructions such as those implemented by at least blocks 512, 514, 516, 518 of FIG. 5, block 610 of FIG. 6, and block 704 of FIG. 7. In some examples, the calibration controller 246 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the calibration controller 246 may be instantiated by any other combination of hardware, software, and/or firmware. For example, the calibration controller 246 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the RAN-AI LCM 102 includes means for selecting an algorithm. For example, the means for selecting an algorithm may be implemented by the algorithm selection controller 304. In some examples, the algorithm selection controller 304 may be instantiated by programmable circuitry such as the example programmable circuitry 812 of FIG. 8. For instance, the algorithm selection controller 304 may be instantiated by the example microprocessor 900 of FIG. 9 executing machine executable instructions such as those implemented by at least blocks 708 of FIG. 7. In some examples, the algorithm selection controller 304 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the algorithm selection controller 304 may be instantiated by any other combination of hardware, software, and/or firmware. For example, the algorithm selection controller 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the RAN-AI LCM 102 and the inference runtime pipeline 104 of FIG. 1 is illustrated in FIG. 2, one or more of the elements, processes, and/or devices illustrated in FIG. 2 may be combined, divided, re-arranged, omitted, eliminated, and/or implemented in any other way. Further, the example data preparation controller 208, the example model inference controller 210, the example robustness protection controller 212, and/or, more generally, the example inference runtime pipeline 104 of FIG. 2, and/or the example interface 216, the example ML metric calculator 218, the example data analyzer 220, the example performance monitor 222, the example model selector 224, the example pipeline retrainer 226, the example model repository 228, the example model optimizer 232, the example calibration pipeline 234, the example data preparation controller 238, the example calibration dataset store 242, the example model inference controller 244, and the example calibration controller 246, and/or, more generally, the example RAN-AI LCM 102 may be implemented by hardware alone or by hardware in combination with software and/or firmware. Thus, for example, any of the example data preparation controller 208, the example model inference controller 210, the example robustness protection controller 212, and/or, more generally, the example inference runtime pipeline 104 of FIG. 2, and/or the example interface 216, the example ML metric calculator 218, the example data analyzer 220, the example performance monitor 222, the example model selector 224, the example pipeline retrainer 226, the example model repository 228, the example model optimizer 232, the example calibration pipeline 234, the example data preparation controller 238, the example calibration dataset store 242, the example model inference controller 244, and the example calibration controller 246, and/or, more generally, the example RAN-AI LCM 102, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example RAN-AI LCM 102 and/or the inference runtime pipeline 104 of FIG. 2 may include one or more elements, processes, and/or devices in addition to, or instead of, those illustrated in FIG. 2, and/or may include more than one of any or all of the illustrated elements, processes and devices.

Flowcharts representative of example machine-readable instructions, which may be executed by programmable circuitry to implement and/or instantiate the RAN-AI LCM 102 and/or the inference runtime pipeline 104 of FIG. 2 and/or representative of example operations which may be performed by programmable circuitry to implement and/or instantiate the RAN-AI LCM 102 and/or the inference runtime pipeline 104 of FIG. 2, are shown in FIGS. 5-7. The machine-readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine-readable instructions cause an operation, a task, etc., to be carried out and/or performed in an automated manner in the real world. As used herein, “automated” means without human involvement.

The programs may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 5-7, many other methods of implementing the example RAN-AI LCM 102 and/or the inference runtime pipeline 104 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 5-7 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read-only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by example programmable circuitry to implement the RAN-AI LCM 102 of FIG. 2 to perform calibrations. The example instructions and/or operations 500 begin at block 502 at which the performance monitor 222 triggers a calibration event in the RAN 106 based on monitoring RAN metrics data (e.g., RAN KPM data from the network production data store 202). For example, the performance monitor 222 sends calibration trigger signaling to the calibration pipeline 234. At block 504, the example performance monitor 222 provides calibration configuration information to the calibration pipeline 234. At block 506, the example model inference controller 244 accesses a RAN-AI model (e.g., an ML model) of the RAN 106 from the model repository 228. For example, the model inference controller 244 pulls or accesses a RAN-AI model (e.g., the RAN-AI model 206) that is indicated in the calibration configuration information of block 504 as the subject of the calibration.

At block 508, the example data preparation controller 238 accesses a calibration dataset 242 from the network production data store 202. At block 510, the example model inference controller 244 runs the RAN-AI model 206 to generate predictions of the RAN-AI model 206 based on the calibration dataset 242. At block 512, the example calibration controller 246 determines uncertainty scores corresponding to predictions of the RAN-AI model 206 of the RAN 106. At block 514, the example calibration controller 246 determines a conformity threshold (τ) based on the uncertainty scores of block 512. At block 516, the example calibration controller 246 updates the model repository 228 to include the conformity threshold (τ). At block 518, the example calibration controller 246 updates a robustness protection layer implemented by the robustness protection controller 212 in the inference runtime pipeline 104 to include the conformity threshold (τ). The example instructions and/or operations 500 end.

FIG. 6 is a flowchart representative of example machine-readable instructions and/or example operations 600 that may be executed, instantiated, and/or performed by example programmable circuitry to implement the RAN-AI LCM 102 of FIG. 2 to create new data classification labels and perform calibrations of uncertainty measures of RAN-AI models (e.g., the RAN-AI model 206). The instructions and/or operations 600 begin at block 602 at which the example interface 216 collects, or accesses, RAN KPM data associated with performance of a RAN-AI model (e.g., an ML model such as the RAN-AI model 206) in the RAN 106. For example, the interface 216 can retrieve substantially real-time RAN KPM data from the network production data store 202.

At block 604, the example data analyzer 220 extracts features from RAN KPM data from the network production data store 202. For example, the data analyzer 220 may extract features from substantially real-time RAN KPM data (e.g., current RAN KPM data). At block 606, the example data analyzer 220 detects a data distribution shift based on the features. In some examples, the data analyzer 220 is to detect the data distribution shift based on a difference between a first histogram of historical features (e.g., of historical RAN KPM data in the network production data store 202) and a second histogram of the features extracted at block 604 from the RAN KPM data. In some examples, the data distribution shift corresponds to a current operating condition of the RAN 106 diverging from a training scenario of the RAN-AI model 206 in the RAN 106. For example, the data analyzer 220 may detect the data distribution shift by comparing the features of block 604 with training dataset features used to train the RAN-AI model 206 before the current RAN KPM data in the network production data store 202 was generated.

At block 608, the example data analyzer 220 generates data class labels based on the features. The example data analyzer 220 may update new data class labels in association with corresponding RAN KPM data in the network production data store 202. At block 610, the example calibration controller 246 performs a calibration process on the RAN-AI model 206 based on the data class labels after the detection of the data distribution shift. For example, the data analyzer 220 can inform the performance monitor 222 of the data distribution shift and, in response to the data distribution shift, the performance monitor 222 can signal a calibration trigger to the calibration pipeline 234 to cause the calibration controller 246 to calibrate an uncertainty measure of the RAN-AI model. In examples disclosed herein, the calibration process is to increase a robustness of predictions of the RAN-AI model 206 after the detection of the data distribution shift. The example instructions and/or operations 600 end.

FIG. 7 is a flowchart representative of example machine-readable instructions and/or example operations 700 that may be executed, instantiated, and/or performed by example programmable circuitry to implement the RAN-AI LCM 102 of FIG. 2 to select an EQ algorithm that decreases uncertainties of predictions of a RAN-AI model (e.g., the RAN-AI model 302) of the RAN-AI LCM 102. The instructions and/or operations 700 begin at block 702 at which the model inference controller 244 accesses a RAN-AI model 302 (e.g., an ML model) from the model repository 228. At block 704, the example calibration controller 246 performs a calibration on an uncertainty measure of the RAN-AI model 302. At block 706, the robustness protection controller 212 performs robustness protection. For example, the robustness protection controller 212 computes uncertainty scores s(x,y)=1−f_{y}(x) and determines a prediction set C(x)={y|s(x,y)<τ} based on soft labels (f_{y}(x)) from the RAN-AI model 302. At block 708, the example algorithm selection controller 304 selects an EQ algorithm. For example, the algorithm selection controller 304 can select the EQ algorithm based on the prediction set C(x) and additional EQ algorithm information (e.g., performance data and RAN KPM complexity metrics from the network production data store 202). The instructions and/or operations 700 end.

FIG. 8 is a block diagram of an example programmable circuitry platform 800 structured to execute and/or instantiate the example machine-readable instructions and/or the example operations of FIGS. 5-7 to implement the RAN-AI LCM 102 and/or the inference runtime pipeline 104 of FIG. 2. The programmable circuitry platform 800 can be, for example, a server, a self-learning machine (e.g., a neural network), a base station, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, VPUs, DSPs, and/or microcontrollers from any desired family or manufacturer. The programmable circuitry 812 may be implemented by one or more semiconductor based (e.g., silicon based) devices. In this example, the programmable circuitry 812 implements the example data preparation controller 208, the example model inference controller 210, the example robustness protection controller 212, and/or, more generally, the example inference runtime pipeline 104 of FIG. 2, and/or the example ML metric calculator 218, the example data analyzer 220, the example performance monitor 222, the example model selector 224, the example pipeline retrainer 226, the example model repository 228, the example model optimizer 232, the example calibration pipeline 234, the example data preparation controller 238, the example model inference controller 244, and the example calibration controller 246, and/or, more generally, the example RAN-AI LCM 102.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816. In some examples, one or more of the main memory 814, 816 implements the example calibration dataset store 242 of FIG. 2.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 820 implements the example interface 216 of FIG. 2.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or a speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIGS. 5-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 5-7 to effectively instantiate the circuitry of FIG. 2 as logic circuits to perform operations corresponding to those machine-readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine-readable instructions and/or operations represented by the flowcharts of FIGS. 5-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine-readable instructions. However, once configured, the FPGA circuitry 1000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine-readable instructions represented by the flowchart(s) of FIGS. 5-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 5-7. As such, the FPGA circuitry 1000 may be configured and/or structured to effectively instantiate some or all of the operations/functions corresponding to the machine-readable instructions of the flowcharts of FIGS. 5-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine-readable instructions of FIGS. 5-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine-readable instructions of FIGS. 5-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine-readable instructions represented by the flowchart(s) of FIGS. 5-7 to perform first operation(s)/function(s), the FPGA circuitry 1000 of FIG. 10 may be configured and/or structured to perform second operation(s)/function(s) corresponding to a second portion of the machine-readable instructions represented by the flowcharts of FIG. 5-7, and/or an ASIC may be configured and/or structured to perform third operation(s)/function(s) corresponding to a third portion of the machine-readable instructions represented by the flowcharts of FIGS. 5-7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine-readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

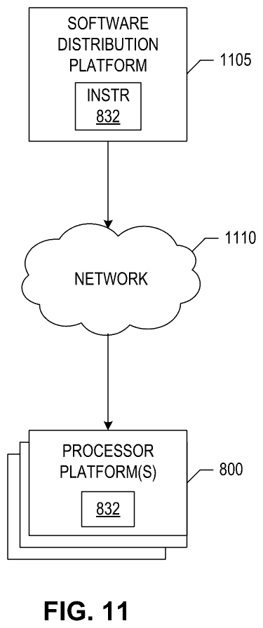

A block diagram illustrating an example software distribution platform 1105 to distribute software such as the example machine-readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine-readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine-readable instructions 832, which may correspond to the example machine-readable instructions of FIGS. 5-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 832 from the software distribution platform 1105. For example, the software, which may correspond to the example machine-readable instructions of FIG. 5-7, may be downloaded to the example programmable circuitry platform 800, which is to execute the machine-readable instructions 832 to implement the RAN-AI LCM 102 and/or the inference runtime pipeline 104 of FIG. 2. In some examples, one or more servers of the software distribution platform 1105 periodically offer, transmit, and/or force updates to the software (e.g., the example machine-readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” and “substantially real-time” refer to occurrence in a near instantaneous manner recognizing there may be real-world delays for computing time, transmission, etc. Thus, unless otherwise specified, “substantially real time” and “substantially real-time” refer to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that increase robustness of RAN-AI model predictions in RAN-AI life cycle management. Disclosed systems, apparatus, articles of manufacture, and methods improve the performance of a computing device in a RAN by increasing the robustness of AI/ML solutions in RANs under diverse, highly dynamic, and sometimes even adversarial conditions in wireless communications, including wireless channel variations, user mobility, traffic dynamics, and interference from neighboring cells. Disclosed systems, apparatus, articles of manufacture, and methods are accordingly directed to one or more improvement(s) in the operation of a machine such as a computer or other electronic device.

Example methods, apparatus, systems, and articles of manufacture to increase robustness of RAN-AI model predictions in RAN-AI life cycle management are disclosed herein. Further examples and combinations thereof include the following:
Example 1 includes an apparatus comprising interface circuitry to access radio access network (RAN) metrics data associated with performance of a machine learning (ML) model in a RAN, machine-readable instructions, and at least one programmable circuitry to be programmed by the machine-readable instructions to extract features from the RAN metrics data, detect a data distribution shift based on the features, generate data class labels based on the features, and calibrate the ML model based on the data class labels after the detection of the data distribution shift.
Example 2 includes any preceding clause(s) of Example 1, wherein the RAN metrics data includes at least one of a signal-to-noise ratio (SNR), a signal-to-interference-plus-noise ratio (SINR), resource block (RB) utilization, a number of spatial streams to be transmitted with multiple antennas, or user equipment (UE) mobility.
Example 3 includes any preceding clause(s) of any one or more of Examples 1-2, wherein one or more of the at least one programmable circuitry is to compare the features with training dataset features to detect the data distribution shift, the training dataset features used to train the ML model before the RAN metrics data is generated.
Example 4 includes any preceding clause(s) of any one or more of Examples 1-3, wherein one or more of the at least one programmable circuitry is to calibrate the ML model to increase a robustness of predictions of the ML model after the detection of the data distribution shift.
Example 5 includes any preceding clause(s) of any one or more of Examples 1-4, wherein one or more of the at least one programmable circuitry is to detect the data distribution shift based on a difference between a first histogram of historical features and a second histogram of the features from the RAN metrics data.
Example 6 includes any preceding clause(s) of any one or more of Examples 1-5, wherein the data distribution shift corresponds to divergence of a current operating condition of the RAN from a training scenario of the ML model in the RAN.
Example 7 includes at least one non-transitory machine-readable storage medium comprising instructions to cause at least one programmable circuitry to at least identify an event in a radio access network (RAN) based on RAN metrics data, access a machine learning (ML) model of the RAN, access a calibration dataset, determine uncertainty scores corresponding to predictions of the ML model of the RAN, the predictions based on the calibration dataset, determine a conformity threshold based on the uncertainty scores, and update a robustness protection layer in an inference pipeline to include the conformity threshold.
Example 8 includes any preceding clause(s) of Example 7, wherein the conformity threshold is a cutoff value, the instructions to cause one or more of the at least one programmable circuitry to exclude at least one of the predictions of the ML model from incoming real-time data in the inference pipeline after a determination that the at least one of the predictions exceeds the cutoff value.
Example 9 includes any preceding clause(s) of any one or more of Examples 7-8, wherein the instructions are to cause one or more of the at least one programmable circuitry to, after identification of the calibration event, provide calibration configuration information, the calibration configuration information including a target quantile.
Example 10 includes any preceding clause(s) of any one or more of Examples 7-9, wherein the instructions are to cause one or more of the at least one programmable circuitry to determine the conformity threshold based on a confidence level.
Example 11 includes any preceding clause(s) of any one or more of Examples 7-10, wherein the instructions are to cause one or more of the at least one programmable circuitry to update the model repository to include the conformity threshold.
Example 12 includes any preceding clause(s) of any one or more of Examples 7-11, wherein the RAN metrics data includes at least one of a signal-to-noise ratio (SNR), a signal-to-interference-plus-noise ratio (SINR), resource block (RB) utilization, a number of spatial streams to be transmitted with multiple antennas, or user equipment (UE) mobility.
Example 13 includes any preceding clause(s) of any one or more of Examples 7-12, wherein the uncertainty scores are defined as s(xᵢ, yᵢ)=1−f_{y}_{ᵢ}(xᵢ), where f_{y}(x) is a predicted probability of class y with input of x the ML model.
Example 14 includes an apparatus comprising interface circuitry, machine-readable instructions, and at least one programmable circuitry to be programmed by the machine-readable instructions to trigger a calibration event in a radio access network (RAN) based on RAN metrics data, access a machine learning (ML) model of the RAN from a model repository, access a calibration dataset, determine uncertainty scores corresponding to predictions of the ML model of the RAN, the predictions based on the calibration dataset, determine a conformity threshold based on the uncertainty scores, and update a robustness protection layer in an inference pipeline to include the conformity threshold.
Example 15 includes any preceding clause(s) of Example 14, wherein the conformity threshold is a cutoff value, one or more of the at least one programmable circuitry to exclude at least one of the predictions of the ML model from incoming real-time data in the inference pipeline after a determination that the at least one of the predictions exceeds the cutoff value.
Example 16 includes any preceding clause(s) of any one or more of Examples 14-15, wherein one or more of the at least one programmable circuitry is to, after a trigger of the calibration event, provide calibration configuration information, the calibration configuration information including a target quantile.
Example 17 includes any preceding clause(s) of any one or more of Examples 14-16, wherein one or more of the at least one programmable circuitry is to determine the conformity threshold based on a confidence level.
Example 18 includes any preceding clause(s) of any one or more of Examples 14-17, wherein one or more of the at least one programmable circuitry is to update the model repository to include the conformity threshold.
Example 19 includes any preceding clause(s) of any one or more of Examples 14-18, wherein the RAN metrics data includes at least one of a signal-to-noise ratio (SNR), a signal-to-interference-plus-noise ratio (SINR), resource block (RB) utilization, a number of spatial streams to be transmitted with multiple antennas, or user equipment (UE) mobility.
Example 20 includes any preceding clause(s) of any one or more of Examples 14-19, wherein the uncertainty scores are defined as s(xᵢ, yᵢ)=1−f_{y}_{ᵢ}(xᵢ), where f_{y}(x) is a predicted probability of class y with input of x the ML model.
Example 21 includes a method comprising detecting a calibration event in a radio access network (RAN) based on RAN metrics data, accessing a machine learning (ML) model of the RAN, generating predictions of the ML model of the RAN based on a calibration dataset, determining uncertainty scores corresponding to the predictions of the ML model of the RAN, determining a conformity threshold based on the uncertainty scores, and updating a robustness protection layer in an inference pipeline to include the conformity threshold.
Example 22 includes any preceding clause(s) of Example 21, wherein the conformity threshold is a cutoff value, the method including causing the robustness protection layer in the inference pipeline to exclude ones of the predictions of the ML model from incoming real-time data after a determination that the ones of the predictions exceed the cutoff value.
Example 23 includes any preceding clause(s) of any one or more of Examples 21-22, including, after detecting the calibration event, providing calibration configuration information, the calibration configuration information including a target quantile.
Example 24 includes any preceding clause(s) of any one or more of Examples 21-23, including determining the conformity threshold based on a confidence level.
Example 25 includes any preceding clause(s) of any one or more of Examples 21-24, including updating a model repository to include the conformity threshold.
Example 26 includes any preceding clause(s) of any one or more of Examples 21-25, wherein the RAN metrics data includes at least one of a signal-to-noise ratio (SNR), a signal-to-interference-plus-noise ratio (SINR), resource block (RB) utilization, a number of spatial streams to be transmitted with multiple antennas, or user equipment (UE) mobility.
Example 27 includes any preceding clause(s) of any one or more of Examples 21-26, wherein the triggering of the calibration event is based on a RAN performance, a prediction accuracy performance of the ML model, or a data distribution shift.
Example 28 includes an apparatus comprising means for accessing radio access network (RAN) metrics data associated with performance of a machine learning (ML) model in a RAN, means for analyzing data to extract features from the RAN metrics data, detect a data distribution shift based on the features, and generate data class labels based on the features, and means for calibrating the ML model based on the data class labels after the detection of the data distribution shift.
Example 29 includes any preceding clause(s) of Example 28, wherein the RAN metrics data includes at least one of a signal-to-noise ratio (SNR), a signal-to-interference-plus-noise ratio (SINR), resource block (RB) utilization, a number of spatial streams to be transmitted with multiple antennas, or user equipment (UE) mobility.
Example 30 includes any preceding clause(s) of any one or more of Examples 28-29, wherein the means for analyzing data is to detect the data distribution shift by comparing the features with training dataset features.
Example 31 includes any preceding clause(s) of any one or more of Examples 28-30, wherein the training dataset features are used to train the ML model before the RAN metrics data is generated.
Example 32 includes any preceding clause(s) of any one or more of Examples 28-31, wherein the means for calibrating the ML model is to calibrate the ML model to increase a robustness of predictions of the ML model after the detection of the data distribution shift.
Example 33 includes any preceding clause(s) of any one or more of Examples 28-32, wherein the means for analyzing data is to detect the data distribution shift based on a difference between a first histogram of historical features and a second histogram of the features from the RAN metrics data.
Example 34 includes any preceding clause(s) of any one or more of Examples 28-33, wherein the data distribution shift corresponds to a current operating condition of the RAN diverging from a training scenario of the ML model in the RAN.
Example 35 includes an apparatus comprising means for monitoring performance to identify an event in a radio access network (RAN) based on RAN metrics data, means for selecting a machine learning (ML) model of the RAN, means for preparing data to access a calibration dataset, and means for calibrating to determine uncertainty scores corresponding to predictions of the ML model of the RAN, the predictions based on the calibration dataset, determine a conformity threshold based on the uncertainty scores, and update a robustness protection layer in an inference pipeline to include the conformity threshold.
Example 36 includes any preceding clause(s) of Example 35, wherein the conformity threshold is a cutoff value, the apparatus including means for increasing robustness to exclude at least one of the predictions of the ML model from incoming real-time data in the inference pipeline after a determination that the at least one of the predictions exceeds the cutoff value.
Example 37 includes any preceding clause(s) of any one or more of Examples 35-36, wherein, after identifying the event, the means for monitoring performance is to provide calibration configuration information, the calibration configuration information including a target quantile.
Example 38 includes any preceding clause(s) of any one or more of Examples 35-37, wherein the means for calibrating is to determine the conformity threshold based on a confidence level.
Example 39 includes any preceding clause(s) of any one or more of Examples 35-38, wherein the means for calibrating is to update a model repository to include the conformity threshold.
Example 40 includes any preceding clause(s) of any one or more of Examples 35-39, wherein the RAN metrics data includes at least one of a signal-to-noise ratio (SNR), a signal-to-interference-plus-noise ratio (SINR), resource block (RB) utilization, a number of spatial streams to be transmitted with multiple antennas, or user equipment (UE) mobility.
Example 41 includes any preceding clause(s) of any one or more of Examples 35-40, wherein the uncertainty scores are defined as s(xᵢ, yᵢ)=1−f_{y}_{ᵢ}(xᵢ), where f_{y}(x) is a predicted probability of class y with input of x the ML model.

A method implemented by any one or more of the example apparatus of the preceding examples.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to access radio access network (RAN) metrics data associated with performance of a machine learning (ML) model in a RAN;
machine-readable instructions; and
at least one programmable circuitry to be programmed by the machine-readable instructions to:
extract features from the RAN metrics data;
detect a data distribution shift based on the features;
generate data class labels based on the features; and
calibrate the ML model based on the data class labels after the detection of the data distribution shift.

2. The apparatus of claim 1, wherein the RAN metrics data includes at least one of a signal-to-noise ratio (SNR), a signal-to-interference-plus-noise ratio (SINR), resource block (RB) utilization, a number of spatial streams to be transmitted with multiple antennas, or user equipment (UE) mobility.

3. The apparatus of claim 1, wherein one or more of the at least one programmable circuitry is to compare the features with training dataset features to detect the data distribution shift, the training dataset features used to train the ML model before the RAN metrics data is generated.

4. The apparatus of claim 1, wherein one or more of the at least one programmable circuitry is to calibrate the ML model to increase a robustness of predictions of the ML model after the detection of the data distribution shift.

5. The apparatus of claim 1, wherein one or more of the at least one programmable circuitry is to detect the data distribution shift based on a difference between a first histogram of historical features and a second histogram of the features from the RAN metrics data.

6. The apparatus of claim 1, wherein the data distribution shift corresponds to divergence of a current operating condition of the RAN from a training scenario of the ML model in the RAN.

7. At least one non-transitory machine-readable storage medium comprising instructions to cause at least one programmable circuitry to at least:
identify an event in a radio access network (RAN) based on RAN metrics data;
access a machine learning (ML) model of the RAN;
access a calibration dataset;
determine uncertainty scores corresponding to predictions of the ML model of the RAN, the predictions based on the calibration dataset;
determine a conformity threshold based on the uncertainty scores; and
update a robustness protection layer in an inference pipeline to include the conformity threshold.

8. The at least one non-transitory machine-readable storage medium of claim 7, wherein the conformity threshold is a cutoff value, the instructions to cause one or more of the at least one programmable circuitry to exclude at least one of the predictions of the ML model from incoming real-time data in the inference pipeline after a determination that the at least one of the predictions exceeds the cutoff value.

9. The at least one non-transitory machine-readable storage medium of claim 7, wherein the instructions are to cause one or more of the at least one programmable circuitry to, after identification of the event, provide calibration configuration information, the calibration configuration information including a target quantile.

10. The at least one non-transitory machine-readable storage medium of claim 7, wherein the instructions are to cause one or more of the at least one programmable circuitry to determine the conformity threshold based on a confidence level.

11. The at least one non-transitory machine-readable storage medium of claim 7, wherein the instructions are to cause one or more of the at least one programmable circuitry to update a model repository to include the conformity threshold.

12. The at least one non-transitory machine-readable storage medium of claim 7, wherein the RAN metrics data includes at least one of a signal-to-noise ratio (SNR), a signal-to-interference-plus-noise ratio (SINR), resource block (RB) utilization, a number of spatial streams to be transmitted with multiple antennas, or user equipment (UE) mobility.

13. The at least one non-transitory machine-readable storage medium of claim 7, wherein the uncertainty scores are defined as s(xᵢ, yᵢ)=1−f_{y}_{ᵢ}(xᵢ), where f_{y}(x) is a predicted probability of class y with input x of the ML model.

14. An apparatus comprising:
interface circuitry;
machine-readable instructions; and
at least one programmable circuitry to be programmed by the machine-readable instructions to:
trigger a calibration event in a radio access network (RAN) based on RAN metrics data;
access a machine learning (ML) model of the RAN from a model repository;
access a calibration dataset;
determine uncertainty scores corresponding to predictions of the ML model of the RAN, the predictions based on the calibration dataset;
determine a conformity threshold based on the uncertainty scores; and
update a robustness protection layer in an inference pipeline to include the conformity threshold.

15. The apparatus of claim 14, wherein the conformity threshold is a cutoff value, one or more of the at least one programmable circuitry to exclude at least one of the predictions of the ML model from incoming real-time data in the inference pipeline after a determination that the at least one of the predictions exceeds the cutoff value.

16. The apparatus of claim 14, wherein one or more of the at least one programmable circuitry is to, after a trigger of the calibration event, provide calibration configuration information, the calibration configuration information including a target quantile.

17. The apparatus of claim 14, wherein one or more of the at least one programmable circuitry is to determine the conformity threshold based on a confidence level.

18. The apparatus of claim 14, wherein one or more of the at least one programmable circuitry is to update the model repository to include the conformity threshold.

19. The apparatus of claim 14, wherein the RAN metrics data includes at least one of a signal-to-noise ratio (SNR), a signal-to-interference-plus-noise ratio (SINR), resource block (RB) utilization, a number of spatial streams to be transmitted with multiple antennas, or user equipment (UE) mobility.

20. The apparatus of claim 14, wherein the uncertainty scores are defined as s(xᵢ, yᵢ)=1−f_{y}_{ᵢ}(xᵢ), where f_{y}(x) is a predicted probability of class y with input x of the ML model.
